(19) United States
(12) Patent Application Publication
(10) Pub. No.: US 2005/0034367 A1
(43) Pub. Date: Feb. 17, 2005

(54) Expandable plant growth system

(76) Inventors: Robert C. Morrow, Madison, WI (US); Thomas M. Crabb, Middleton, WI (US); Mark Lee, Middleton, WI (US); David Smith, Madison, WI (US); Katherine Stolp, Manhattan, KS (US); John Vignali, Waunakee, WI (US)

Correspondence Address: David N. Fronek, Esq.;DORSEY & WHITNEY LLP, Intellectual Property Department, 50 South Sixth Street, Suite 1500, Minneapolis, MN, 55402-1498, US

(21) Appl. No.: 10/865,244

(22) Filed: Jun. 10, 2004

Related U.S. Application Data
(60) Provisional application No. 60/477,819, filed on Jun. 12, 2003.

(51) Int. Cl. A01G 9/02

(52) U.S. Cl. 47/65.5; 47/79

(57) ABSTRACT

A storable, portable and expandable plant growth system that allows preparation of seed and root media material in a storable state and selective activation through the injection of liquid when germination and growth is desired.

### CROSS-REFERENCE TO RELATED APPLICATION

This application claims priority to U.S. Ser. No. 60/477,819, filed on Jun. 12, 2003, the contents of which are incorporated herein by reference.

### BACKGROUND OF THE INVENTION

1. Field of the Invention

The present invention relates generally to a plant growth system and more specifically to a storable, portable and expandable plant growth system that allows preparation of seed and root media material in a storable state and selective activation through the injection of liquid when germination and growth is desired.

2. Description of the Prior Art

Plant growth systems and apparatus are common in many fields that include crop production, germination, tissue culture growth, horticulture and landscape architecture, and specialty growth systems. Although these systems provide for support of plant growth and development, none is appropriate as a storable, portable and expandable apparatus that can be quickly engaged with water and light to grow plants beyond the seedling stage with passively or actively controlled shoot and root environments.

For productive growth, plants require (at least in a limited manner) controlled temperature, humidity, light, nutrient/water levels and in some cases atmospheric composition. These systems and apparatus may be classified as greenhouses and controlled environment chambers for plant growth, small trays and enclosures for germination and development of seedlings, and coverings and enclosures for outdoor plantings.

On a large scale, greenhouses and controlled environment chambers typically provide temperature and humidity control, lighting input and have water provisioning within the large growth environment. Some of these large systems are made to be portable on wheels or as small assembly projects (much like tents or temporary structures). These systems may be applicable to indoor or outdoor environments. Some of the supporting capabilities within these environments include sensors (for water level, temperature, humidity and atmospheric composition), heaters and other controlled devices to manipulate and change the environment to some preset level.

Additional prior structures include stands and displays for plants in addition to other plant propagation support components such as augers, plant structural supports and means of water input. These are typically passive apparatus that require external lighting, but maintain the higher temperature and humidity environments for seeds and younger plants.

Coverings, structures and enclosures are also available for the protection of plants that are grown outdoors in soil to protect or regulate the environment from extremes. These apparatus provide additive protection to supplement natural environmental factors to minimize adverse variation in temperature, humidity and root water content. Examples include transparent coverings for plants to allow light transmission, but protecting from low temperatures and dry air, plants in tubes and other nursery growing systems.

While many of the above are satisfactory in certain limited environments for certain limited applications, there is a continuing need for a plant growth system which improves upon the prior art and which provides a storable, portable and expandable plant growth system.

### SUMMARY OF THE INVENTION

The present invention provides a plant growth system and more specifically a storable, portable and expandable plant growth system that can be activated for use by adding water and light in a relatively stable air environment relative to temperature, humidity and environmental composition. Through manual or automated maintenance of the system shoot or root environment of the present invention, the plants will grow to full maturity in a controlled environment with improved plant productivity.

In general, the system of the present invention includes an opaque, transparent or translucent base defining a root volume or chamber which is provided with a root growth media and a means for providing and/or extracting water from the media. The preferred embodiment of the invention also includes a substantially transparent shoot volume or chamber which is selectively connectable to, or positionable relative to, the root volume so that the root and shoot chambers are in substantial alignment. The shoot volume functions to accommodate growth of the shoot when the seeds are activated. Preferably, the shoot volume is expandable from a fully retracted position to a fully expanded position and various positions therebetween to accommodate growth of the shoot and to ensure optimum light to the shoot during the growth cycle. Means are also preferably provided in the shoot volume to control humidity and temperature in the growth chamber.

Accordingly, because of the expandable characteristic of the system of the present invention, the system can be packaged and stored in its collapsed position anywhere from 50% to 5% or less of its full growth volume. The system is stored dry and has a life expectancy that can exceed one year or more depending upon the seed type, the root media and various other factors. This provides a means of selling and distributing prepackaged gardens or growth systems that include a plant growth assembly, seeds, watering device, root barrier and instructions that can be stored and engaged without significant concern of shelf life. The low volume makes shipment and packaging less expensive and enables users to keep many systems in storage for later use. The systems may be sized from extremely small plant systems to large multiple plant systems and may be used outdoors or indoors for year-round use regardless of climate.

A preferred embodiment of the system of the present invention also includes a mechanism to fill the root volume with water and/or extract water from the root volume through the same means so that the root volume can be metered for accurate root zone water and aeration levels. The system can also be integrated into automated watering systems which maintain appropriate water and aeration for one or more systems.

The expandable feature of the shoot or growth chamber includes openings, vents or other means that are adjustable to allow passive exchange of humidity. This allows the humidity levels within the enclosure to increase to levels appropriate for specific plant varieties or stages of growth or to be decreased for certain other plant varieties or stages of plant growth. In addition, the extendable, deployable shoot enclosure can accommodate a wide range of plant heights and breadths and, because of its transparency, allows light transmission through the top and sides of the enclosure. Preferably, access to the plant is provided through the adjustable opening within the shoot chamber, but access can also be provided by removal of the shoot enclosure. The expandability of the shoot chamber also allows the plant to be maintained directly adjacent to the light source throughout the plant's life cycle, thereby allowing maximum light interception from artificial or natural light sources.

The system of the preferred embodiment has a variety of applications included, but not limited to, personal gardening, research, education and training, emergency food supply, commercial plant propagation and decoration or plantscaping. Versions of the system of the present invention may also have application for plant growth in space or zero gravity environments and for classrooms and other educational environments. Large scale applications of the system are applicable for larger production of vegetables or other food related crops and may integrate sophisticated monitoring and control systems.

These and other features of the present invention will become apparent with reference to the drawings, the description of the preferred embodiment and the appended claims.

### DESCRIPTION OF THE DRAWINGS

FIG. 1 is an isometric view of the plant growth system in accordance with the present invention as shown in its fully collapsed position.

FIG. 2 is an isometric view of the plant growth system of the present invention in a fully expanded position.

FIG. 3 is an isometric, partially exploded, view of the root chamber of the system of the present invention.

FIG. 4 is a view, partially in section, of the root chamber without the root barrier as viewed along the section line 4-4 of FIG. 3.

FIG. 5 is a view, partially in section, of the root chamber filled with root growth media and provided with seeds.

FIG. 6 is an isometric view of the plant growth system in accordance with the present invention showing the shoot growth chamber in its fully expanded position and with the adjustable vent of the growth chamber partially open.

FIG. 7 is a schematic view of a moisture distribution/extraction system in accordance with the present invention.

FIG. 8 is an enlarged view showing the means for adjusting the opening of the shoot chamber vent.

FIG. 9 is a schematic view of a system for automatically controlling environmental conditions in the shoot chamber.

FIG. 10 is a view, partially in section, of a further embodiment of the base and root chamber of the plant growth system of the present invention.

### DESCRIPTION OF THE PREFERRED EMBODIMENT

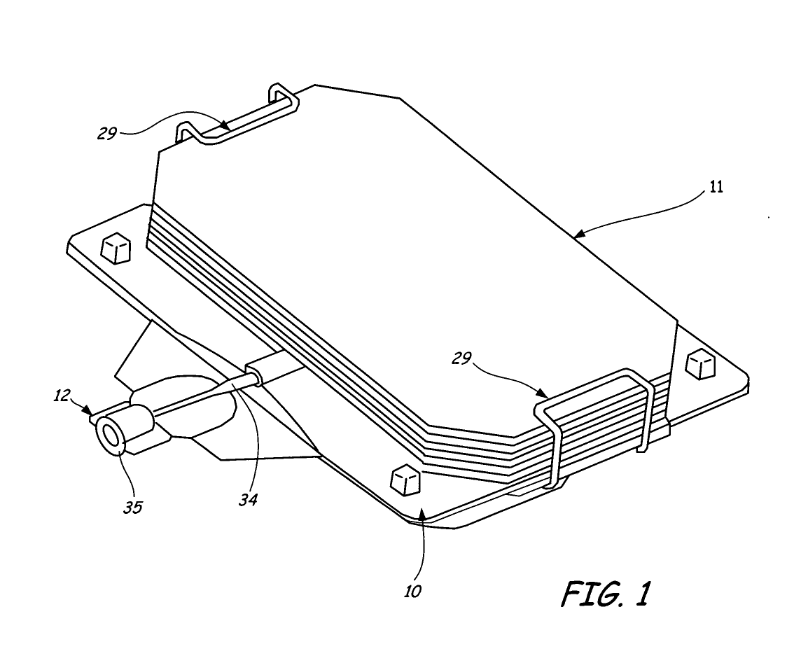

With general reference to FIG. 1-6, the plant growth system of the preferred embodiment includes a base or root vessel 10, an expandable shoot chamber 11 and a means 12 for injecting water into or extracting water from the root vessel 10. In the preferred embodiment, the shoot chamber 11 is selectively connectable to, or positionable relative to, the root vessel 10, with the chamber 11 and a root chamber 15 of the vessel 10 being substantially aligned, so that seeds that germinate and begin to grow in the root chamber 15 will grow into the shoot chamber 11.

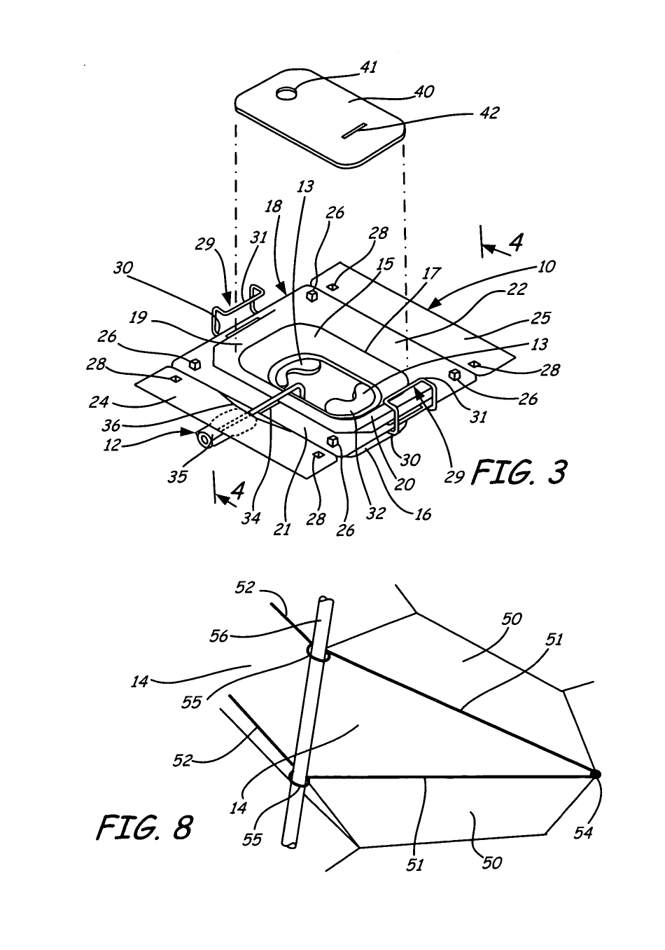

With continuing general reference to FIGS. 1-6 and more specific reference to FIGS. 3, 4 and 5, the base or root vessel 10 comprises a tray-like structure having a centrally located recessed area defining a root volume or chamber 15. In the preferred embodiment, the root volume 15 is defined by the wall portion 16. The wall portion 16 includes a side wall portion and a bottom wall portion. A substantially planar, laterally extending lip 18 (FIG. 3) is integrally joined with the top edge 17 of the wall portion 16 and extends outwardly therefrom. The peripheral, laterally extending lip 18 includes end lip portions 19 and 20 and side lip portions 21 and 22. A pair of shoot chamber connection flaps 24 and 25 are hingedly connected respectively to the outer edges of the side lip portions 21 and 22. These flaps 24 and 25 are designed to be rotated up and over the respective lip portions 21 and 22 to capture a respective bottom edge portion of the shoot chamber 11, and thus selectively retain or connect the shoot chamber 11 to the base or root vessel 10.

In the preferred embodiment, the lip portions 21 and 22 are provided with a pair of outwardly extending projections 26 and the flaps 24 and 25 are provided with corresponding complementary recessed portions 28. When the flaps 24 and 25 are pivoted upwardly and onto the top surface of the lip portions 21 and 22, the projections 26 are inserted or snapped into the recessed portions 28 to retain the flaps 24 and 25 relative to the lip portions 21 and 22. This selectively secures the shoot chamber 11 to the base 10.

The base or root vessel 10 also includes a pair of wire clips 29 or other means for retaining the shoot chamber 11 in a collapsed position and in selected expanded positions. The clips 29 include wire, legs 30 which in the preferred embodiment are connected with the base 10. This connection may be accomplished by extending end portions of the clips 29 through holes in chamber 15 and retaining the clips therein by bending the ends toward one another or by connecting inner ends of the clips 29 to the underside of the lip portions 19 and 20. The clips 29 also include upwardly and inwardly extending generally U-shaped wire portions 31. These portions 31 are designed for connection with a portion of the shoot chamber 11 as shown and described below. The clips 29 are designed to be bent outwardly for a limited distance to allow the shoot chamber 11, or a collapsed portion of the chamber 11, to pass the clips. When released, these inwardly extending U-shaped portions 31 return to the position shown in FIGS. 1 and 3 to engage and retain a selected portion of the shoot volume 11 adjacent to and in alignment with the root chamber 15. This bending movement of the clips 29 may be facilitated by the flexible nature of the lip portions 19 and 20 or by otherwise hingedly connecting the clips 29 to the lip portions 19 and 20.

The base or root vessel 10 may be constructed of a variety of materials and may be transparent, translucent or opaque. In the preferred embodiment, the base 10 is constructed of a thin plastic material which can be blow molded, injection molded, or otherwise formed in a single step into the configuration of the base 10, such as BIPS or RPVC, and with or without UV inhibitors.

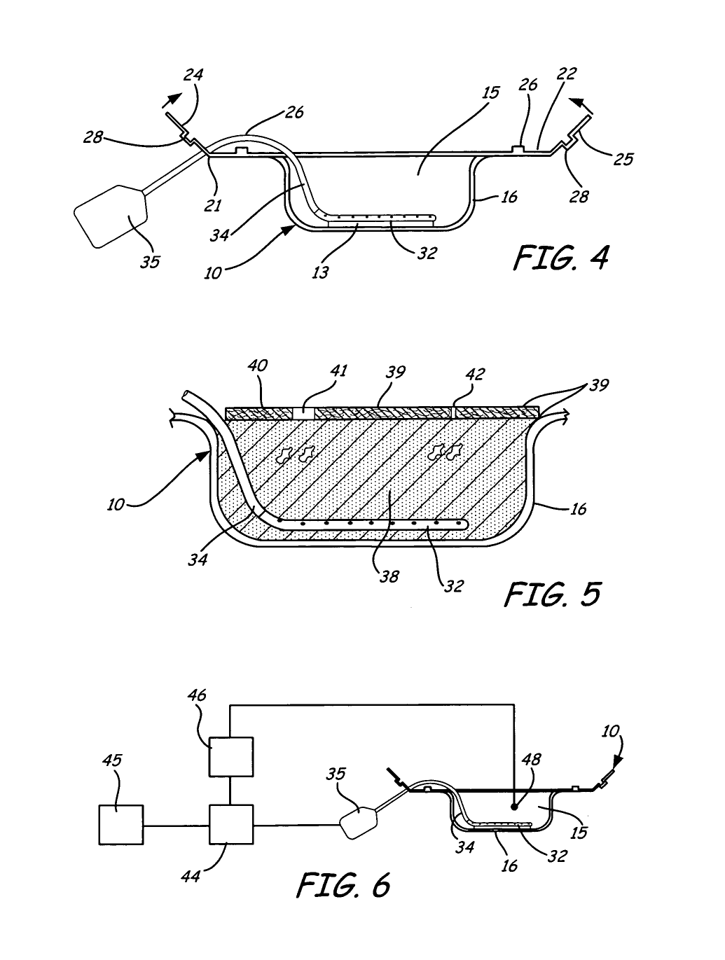

As shown best in FIGS. 3, 4 and 5, the root volume 15 is provided with a means for injecting and/or extracting water from the root volume 15. This means is in the form of the water injection/extraction tube which includes a tube portion 32 positioned within the chamber 15 and a tube portion 34. The tube portion 34 is in communication with the tube 32 and extends out of the chamber 15 and joins with a connection end 35. In the preferred embodiment, the tube portion 32 is provided with a plurality of tiny openings to allow for the dispersion or extraction of water from the chamber 15. Alternatively, the tube portion 32 may be comprised of a soaker tube material without discrete openings. The tube portion 32 may be of any configuration and may be in any position within the chamber 15 as long as it effectively provides water to and/or extracts water from the chamber 15 as desired. As shown in FIGS. 3 and 4, the tube portion 32 is retained relative to the bottom wall of the chamber 15 by the pair of raised portions 13,13.

The tube portion 34 joins with, and is in communication with, the tube portion 32. When assembled, the tube portion 34 extends through a slit 36 between the lip portion 21 and the flap 24 as shown best in FIGS. 3 and 4. This permits the flap 24 to be folded onto the lip portion 21 without interfering with the water injection/extraction means 12. The connection end 35 is connected with a pump or other means such as a syringe to manually or automatically provide water to or extract water from the chamber 15 and the growth media therein.

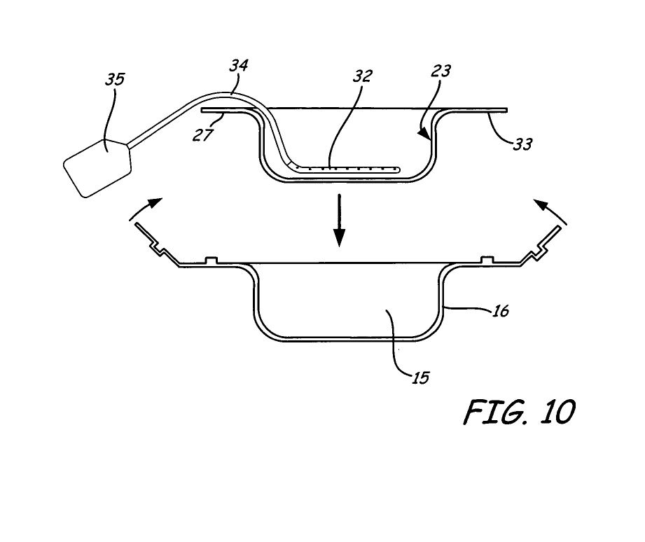

If desired, as shown in FIG. 10, the means 12 can be connected with a separate water impervious liner 23. As shown, the liner 23 has a size and configuration similar to the chamber 15 to allow the liner 23 to be inserted within the chamber 15. In this embodiment, a portion of the tube 34 is connected with an extended lip 27 extending outwardly from one top edge of the liner 23. When joined with the base 10, this portion of the tube 34 and the lip 27 extend through the slit 36. A smaller, outwardly extending lip 33 extends around the remaining top edge of the liner 23. The liner is preferably formed of a thin, flexible plastic material which may be transparent, translucent or opaque.

As shown best in FIG. 5, the root chamber 15, or the liner 23 of FIG. 10, is provided and filled with growth media 38. This growth media can be any material which will facilitate the germination and growth of the seeds embedded therein. Examples of such a media include Arcillite combined with Osmocote slow release fertilizer. This is the preferred media. Other possible materials include vermiculite, balkanite, porous clay material, peat, garden soil and common cat litter, among others. When the plant growth system of the present invention is assembled, seeds 39 of a desired plant are embedded in the growth media 38 for future germination and growth. These seeds 39 may be individually positioned within the media or may be provided within the media on a seed tape or the like.

In certain embodiments as shown best in FIGS. 3 and 5, a root or media barrier 40 is provided. This barrier 40 is provided on top of the media 38 as shown in FIG. 5 and functions to define a root volume that may or may not contain the root media 38 and to limit or otherwise control the light which reaches the seeds and the root system. The root media 38 may be of particulate, foam, peat, or other materials that allow passage of liquid and gas phases. If desired, the root media 38 may be replaced by hydroponic liquid flows that provide sufficient oxygen to the root. The barrier 40 may be provided with one or more holes 41 or slits 42 to allow the sprouts from the seeds 39, and thus the plants, to grow through the barrier 40 and into the shoot chamber 11. The barrier 40 can be made of a variety of materials such as, but not limited to, foam, plastic, paperboard or the like. The barrier 40 is preferably opaque.

As indicated above, the moisture or percentage of water within the chamber 15 can be controlled manually or automatically. FIG. 7 shows a system by which the moisture within the chamber 15 may be controlled automatically. As shown in FIG. 7, a pump 44 is provided to pump water from a water supply 45 to the chamber 15 or to extract water from the chamber 15 and return it to the water supply 45. The pump 44 may be manually controlled or, if desired, automatically controlled via a controller 46. The controller 46 may be designed to maintain the pump at a certain preset pressure (either positive or negative) relative to the chamber 15 and the growth media therein. The controller may also control the pump in response to actual moisture conditions within the chamber 15 via a moisture sensor 48. In general, depending upon the media being utilized and the type of plants which are to be grown in the media, the moisture content within the chamber should be between about 50-80%.

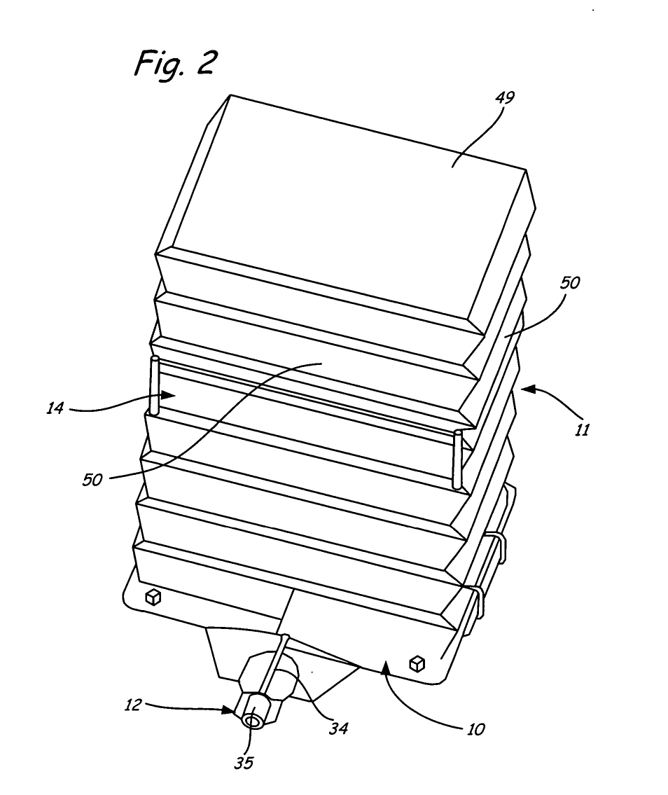

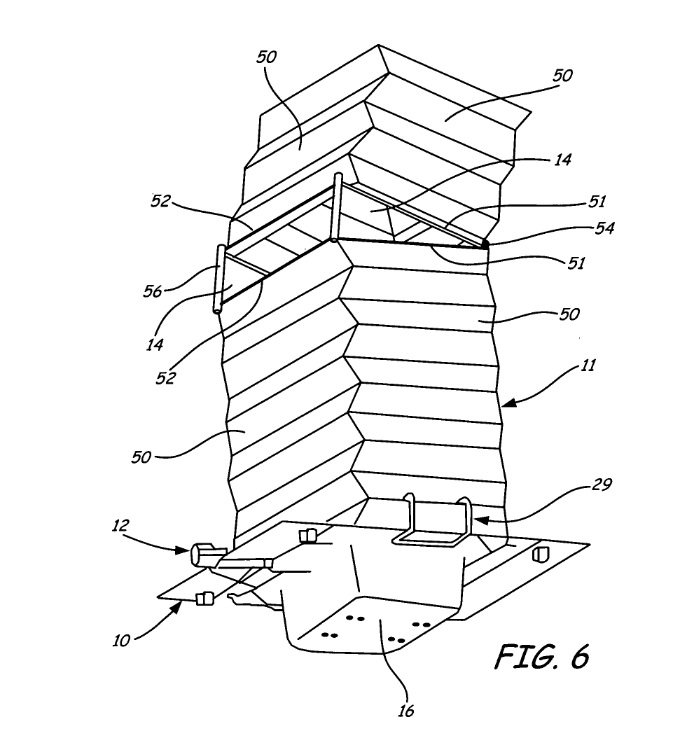

The shoot volume or chamber 11 in accordance with the preferred embodiment comprises an expandable volume or chamber which may be stored in a fully collapsed position as shown in FIG. 1 or may be expanded to a fully expanded condition as shown in FIGS. 2 and 6, or any partially expanded position in between, during use.

In the preferred embodiment, the chamber 11 includes an open bottom and a closed top 49 (FIG. 2) and a plurality (preferably four) side walls 50. If desired, the chamber 11 can also embody a single, continuous side wall configuration such as a cylinder with a circular, elliptical or other shaped cross-section. As shown, in the preferred embodiment, these side walls 50 are pleated to permit the entire shoot chamber 11 to be expanded to accommodate the plant growth within the chamber or collapsed for storage or during non-use. In the preferred embodiment, the bottom pleat at the ends of the side walls 50, opposite to the top 49, engage the peripheral lip 18 of the base 10, with the bottom pleat edges of opposite side walls 50 being captured or sandwiched between the lip portions 21 and 22 and the respective hinged flaps 24 and 25. The bottom pleat edges of the other opposite side walls 50 are retained relative to the lip 18, and in particular the lip portions 19 and 20, by the retaining clips 29.

When the shoot chamber 11 is in its fully collapsed position as shown in FIG. 1, the retaining clips 29 function to retain the chamber 11 in its collapsed position by extending and clipping over the top 49. As the chamber 11 is expanded, the clips 29 can be outwardly flexed and then allowed to snap back into retaining position to engage any one of the plurality of pleats along the side walls 50. This enables the expansion, and thus the size, of the chamber 11 to be manually controlled in response to the plant growth. By minimizing the expansion of the chamber 11 when the shoot is small, the light source can be moved closer to the shoot to facilitate enhanced growth.

The shoot chamber 11 can be made from a variety of materials. Preferably it is constructed of a thin plastic, substantially transparent material or other material that allows sufficient growth light to reach the shoot within the chamber 11. The material is also preferably sufficiently stiff to maintain an upright, expanded position. The material should also preferably be such that when external forces are removed, it will tend to assume an expanded, or at least partially expanded, position. Examples of such materials are Mylar or Teflon. Although the preferred embodiment shows pleated side walls 50 as the means for providing an expandable volume or chamber 11, other means could be utilized as well. Examples include side walls of flat plastic sheets on a roll, support columns filled with air, wire embedded in the bellows walls, or any other deployable structure that enables the shoot chamber to be selectively collapsed and expanded.

The shoot chamber 11 of the preferred embodiment has an open bottom, however, if desired, a bottom can be provided. Such bottom may have one or more openings which correspond to openings in the barrier 40 (FIG. 3) or with the position of seeds in the chamber 15 to accommodate growth of shoots through such holes.

As shown best in FIGS. 2 and 6, the chamber 11 is provided with a selectively controllable opening or vent 14. This opening 14 enables the interior of the shoot chamber 11 to be in communication with the ambient environment conditions for the purpose of controlling the temperature, humidity and other environmental conditions within the chamber 11. Depending upon the ambient temperature and humidity, and the desired temperature and humidity in the chamber 11, the vent 14 is either closed, or opened to a certain size. Although a variety of structures may be provided to facilitate a controlled opening within the chamber 11, the structure of the preferred embodiment, as shown best in FIGS. 6 and 8 includes a pair of wire sections 51, 51 connected to separated portions of opposite side walls 50, a pair of wire sections 52, 52 connected with a separated portion of a third side wall 50 and a wire section or other hinge connection at a point 54 on the fourth side wall 50 of the chamber 11. As shown best in FIG. 8, the wire sections 51 and 52 are integral with one another and are joined by a loop 55. A piece of stiff, but compressible, plastic tubing or other structure 56 extends through the loops 55 as shown to adjust the extent to which the wire sections 52,52 are separated from one another. This adjustment is made manually by sliding the tubing 56 through the loops 55, with the extent of the opening being retained by friction between the tubing 56 and the loops 55. The relative position of the tubing 56 and the loops 55 defines the size of the opening or vent 14 within the chamber 11. As indicated, the structure shown in FIGS. 6 and 8 is but one of many possible structures that can be provided to adjust the opening vent 14 in the chamber 11. Preferably, however, such means must be capable of providing an adjustable opening or vent within the chamber 11. Such means must also preferably be near its upper end, to control the temperature, humidity and other environmental conditions within the chamber 11.

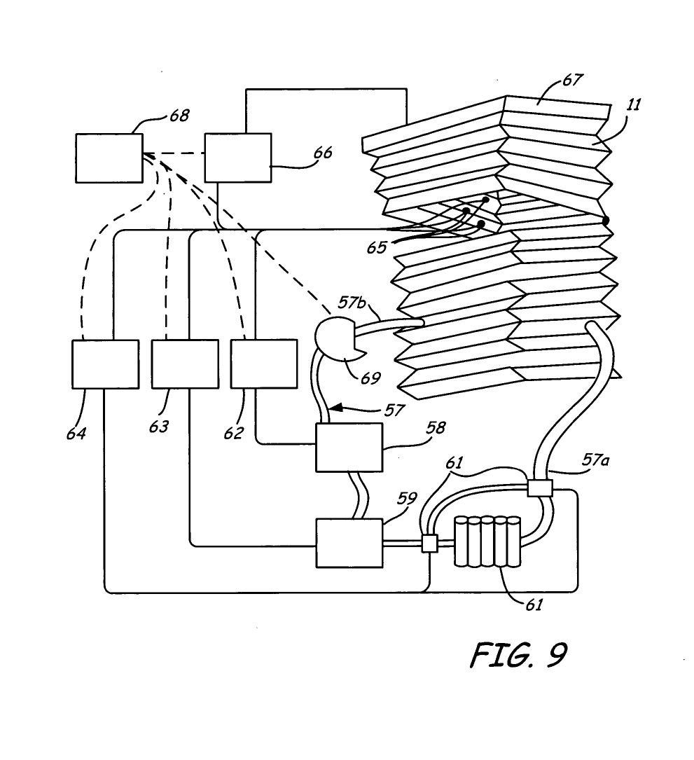

The manually adjustable vent opening 14 as shown in the embodiment of FIG. 6 is particularly applicable when the growth system is maintained at a location where the ambient humidity, temperature and other conditions are compatible with the desired environment within the shoot chamber 11. If the ambient environmental conditions are not compatible, means such as a transport tube or duct 57a and 57b of FIG. 9 may be used to introduce the desired atmosphere (humidity, temperature, atmospheric composition, etc.) into, or remove atmosphere from, the chamber 11. In this case, the vent 14 may be closed. Introduction of desired environmental conditions into the shoot chamber 11 may be done manually or may be done automatically as shown in FIG. 9.

FIG. 9 shows a system in which the environment within the shoot chamber 11 may be automatically controlled for temperature, humidity, composition, and other characteristics. In a preferred embodiment, atmosphere in the shoot chamber 11 is transported or moved from the chamber 11 by a transport duct or tube 57a. The duct 57a enables the shoot environment atmosphere to be transported or moved through or past apparatus 58 that change the temperature, apparatus 59 that change humidity and apparatus 60 that affect or change the atmospheric composition. Preferably, the alternation of the shoot environment passing through the apparatus 58, 59 and 60 is controlled by suitable control systems 62, 63 and 64 respectively. The movement of the atmosphere from the chamber 11 through the apparatus 58, 59 and 60, and back into the chamber through the duct 57b is controlled by the pump or other air movement means 69.

The extent to which the atmosphere of the chamber 11 is altered by the apparatus 58, 59 and 60 may be controlled by the controllers 62, 63 and 64 to maintain the temperature, humidity and other environmental conditions at desired preset levels. Alternatively, the controllers 62, 63 and 64 can be connected with sensors 65 located within the chamber 11. In this case, the environmental conditions of the atmosphere passing through the tube 57 would be controlled in response to the environmental conditions measured by the sensors. Although controllers 62, 63 and 64 and the sensors 65 are desired for full automated control, the environmental conditions of the atmosphere passing through the duct 57 may be altered without these elements. Further, if desired, some aspects of the atmospheric change may be skipped by using bypass flow controllers such as those identified by reference character 61 in FIG. 9. Such flow controllers 61 may be controlled manually or automatically.

The system of FIG. 9 also includes a light source 67 which is integrated within the top of the shoot chamber 11. This light source may be a conventional growth light, fluorescent light, a plurality of LEDs or any other light source that is conducive to plant growth. The on/off status of the light source 67 as well as the intensity of the light source 67 is controlled by a controller 66. If desired, the controller 66 may be controlled in response to a light sensor (such as one of the sensors 65) to monitor actual light conditions within the shoot chamber environment.

As illustrated schematically in FIG. 9, all of the control systems 62, 63, 64 and 66 may be integrated, if desired, to a higher level of control 68. Use of a control such as that shown by reference character 68, which provides control input to each of the control systems 62, 63, 64 and 66, would enable changing of the various atmospheric conditions, and thus control thereof, from remote user inputs or from data obtained from the individual control systems.

Multiple assemblies such as those shown in FIGS. 2 and 6 may be linked together with similar or different plant species. These multiple assemblies may be controlled passively or actively through control means and systems such as those shown in FIGS. 7 and 9. Also, although not specifically illustrated, multiple root chambers, and related components could be included under a single shoot chamber 11 to maintain separation, if desired, of roots of similar or different plants, while still maintaining the same environmental conditions in the shoot chamber 11. Similarly, multiple shoot chambers 11 could be positioned over a single base or root chamber 16.

Having described the structure of the plant growth system of the present invention in detail, the assembly and use can be understood best as follows.

First, a base 10 with water dispersion/extraction means provided is filled with root media. Seeds of a desired plant are then dispersed within the root media either individually, on a seed tape or otherwise. If needed or desired, a media or root barrier such as the foam barrier 40 is positioned on top of the media. Utilization of a barrier 40 is particularly desired in zero gravity conditions or in other embodiments where the systems may be tipped upside down or otherwise not retained in a horizontal position. The shoot volume 11 is attached to the base either before or after placing the seeds and retained in its collapsed position by the clips 29.

Because the root media is dry, the seeds will not germinate, and thus plant growth will not begin. This enables the entire system to be stored for extended periods of time, up to a year or more, without seed germination.

When it is desired for the system to be activated, water is supplied to the root growth media through the water dispersion tube 32. By supplying a pre-selected amount of water or by over watering and then extracting a certain volume of water, the moisture content within the root volume 15 can be controlled.

As the seed germinates and sprouts, the sprout will grow through the hole 41 or slit 42 in the barrier 40 (if provided) and begin to grow into the shoot chamber 11. To accommodate this growth, expansion of the shoot chamber 11 may be controlled by use of the clips 29 engaging intermediate pleats, and temperature, humidity and other environmental conditions within the shoot chamber 11 are controlled via the vent 14. When the shoot is small, the chamber 11 should preferably be in a partially expanded condition. This permits the light source to be as close as possible to the shoot.

Although the description of the preferred embodiment has been quite specific, it is contemplated that various modifications could be made without deviating from the spirit of the present invention. Accordingly, it is intended that the scope of the present invention be dictated by the appended claims rather than by the description of the preferred embodiment.

1. A portable, storable and expandable plant growth system comprising:
a base defining root chamber;
an expandable shoot chamber; and
said shoot chamber being selectively connectable to, or positionable relative to, said base so that said shoot chamber and said root chamber are substantially aligned.

2. The plant growth system of claim 1 wherein said shoot chamber includes a selectively adjustable opening positioned above said root chamber when said shoot chamber is in its fully expanded position.

3. The plant growth system of claim 1 including a root media within said root chamber.

4. The plant growth system of claim 1 wherein said shoot chamber includes a top and at least one side wall, said side wall including a plurality of vertically spaced pleats including a bottom pleat.

5. The plant growth system of claim 4 wherein said shoot chamber is comprised of a bellows configuration.

6. The plant growth system of claim 4 wherein said bottom pleat is selectively connectable to said base.

7. The plant growth system of claim 6 wherein said plurality of pleats includes a pair of opposed bottom pleats and wherein said base includes a pair of opposed side edge portions, each of said side edge portions including an edge lip and a hinged flap to selectively retain one of said pair of bottom pleats.

8. The plant growth system of claim 1 wherein said shoot chamber is expandable from a collapsed position to a fully expanded position and a plurality of intermediate expanded positions.

9. The plant growth system of claim 8 including a connection mechanism retain said shoot chamber in a selected one of said collapsed position and said plurality of intermediate expanded positions.

10. The plant growth system of claim 9 wherein said connection mechanism is a connection clip.

11. The plant growth system of claim 1 including a water supply mechanism within said root chamber and including an automatic watering system having a water supply tube connected with said water supply mechanism, a water sensor in said root chamber and a control member for supplying water to said root chamber through said tube in response to the status of said water sensor.

12. The plant growth system of claim 1 including a sensor to determine at least one characteristic of the atmosphere within said shoot chamber.

13. The plant growth system of claim 12 including a control system for controlling the atmosphere in said shoot chamber in response to the status of said sensor.

14. A plant growth system comprising:
a plant growth chamber;
a root chamber;
root growth media within said root chamber;
a watering device in communication with said root chamber;
at least one ungerminated seed in said root medium; and
a root barrier in said root chamber, said root barrier having at least one shoot opening.

15. The plant growth system of claim 16 wherein said plant growth chamber is expandable.

16. The plant growth system of claim 15 wherein said plant growth chamber is expandable to a plurality of positions.

17. The plant growth system of claim 16 wherein said root chamber and said plant growth chamber are selectively connectable to one another.

18. The plant growth system of claim 14 including a sensor to determine at least one characteristic of the atmosphere within said shoot chamber

19. The plant growth system of claim 18 including a control system for controlling the atmosphere in said shoot chamber in response to the status of said sensor.

20. The plant growth system of claim 14 including a water supply mechanism within said root chamber and including an automatic watering system having a water supply tube connected with said water supply mechanism, a water sensor in said root chamber and a control member for supplying water to said root chamber through said tube in response to the status of said water sensor.
